(19) United States
(12) Patent Application Publication
(10) Pub. No.: US 2018/0179804 A1
(43) Pub. Date: Jun. 28, 2018

(54) ADJUSTABLE HEADER FOR SLIDING DOORS AND WINDOWS

(71) Applicant: GOLDBRECHT INC., Culver City, CA (US)

(72) Inventors: Marcel FONTIJN, Culver City, CA (US); Joshua Steven RAY, Los Angeles, CA (US)

(73) Assignee: GOLDBRECHT INC., Culver City, CA (US)

(21) Appl. No.: 15/735,760

(22) PCT Filed: May 24, 2017
(86) PCT No.: PCT/US17/34166

§ 371 Date: Dec. 12, 2017

Related U.S. Application Data
(60) Provisional application No. 62/342,369, filed on May 27, 2016.

(51) Int. Cl. E06B 1/52; E06B 1/32; E05D 15/06

(52) U.S. Cl. CPC E06B 1/52; E06B 3/4636; E05D 15/0652; E06B 1/32

(57) ABSTRACT

An adjustable header having a first header piece and a second header piece, which are attachable to each other by a connector.

### CROSS-REFERENCE TO RELATED PATENT APPLICATION

This application claims the benefit of U.S. Provisional Application No. 62/342,369, filed May 27, 2016, in the United States Patent and Trademark Office, the disclosure of which is incorporated herein by reference in its entirety.

### BACKGROUND

### 1. Field

Exemplary embodiments relate to sliding doors and windows, and more particularly, to a header used with sliding doors and windows, the size of which can be adjusted according to a number of tracks necessary for use with the header.

### 2. Description of the Related Art

Conventional headers for sliding doors and windows allow top-hung units to be suspended from the header or are used as a guide for floor supported units. The conventional headers are constructed using stock rectangular bars with ninety-degree angle extrusions.

Conventional headers, however, suffer from several deficiencies, including difficulty of customizing the header according to a change in the number of sliding panels and the headers suffer from poor thermal efficiency.

Exemplary embodiments overcome these shortcomings and solve the problems associated with the prior headers that have been constructed. The exemplary embodiments provide improved thermal efficiency and allow for easy customization of the header.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 illustrates an exploded view of elements of a header according to exemplary embodiments;

FIGS. 2 and 3 illustrate a cross-section view of headers according to a exemplary embodiment;

FIGS. 4 and 5 illustrate a cross-section view of headers according to another exemplary embodiment; and

FIGS. 6-14 illustrate a cross-section view of headers according to exemplary embodiments.

### DETAILED DESCRIPTION

The present inventive concept may allow various kinds of change or modification and various changes in form, and specific exemplary embodiments will be illustrated in drawings and described in detail in the specification. However, it should be understood that the specific exemplary embodiments do not limit the present inventive concept to a specific disclosing form but include every modified, equivalent, or replaced one within the spirit and technical scope of the present inventive concept. In the following description, well-known functions or constructions are not described in detail since they would obscure the invention with unnecessary detail.

The terminology used in the application is used only to describe specific exemplary embodiments and does not have any intention to limit the present inventive concept. Although general terms as currently widely used as possible are selected as the terms used in the present inventive concept while taking functions in the present inventive concept into account, they may vary according to an intention of those of ordinary skill in the art, judicial precedents, or the appearance of new technology. In addition, in specific cases, terms intentionally selected by the applicant may be used, and in this case, the meaning of the terms will be disclosed in corresponding description of the invention. Accordingly, the terms used in the present inventive concept should be defined not by simple names of the terms but by the meaning of the terms and the content over the present inventive concept.

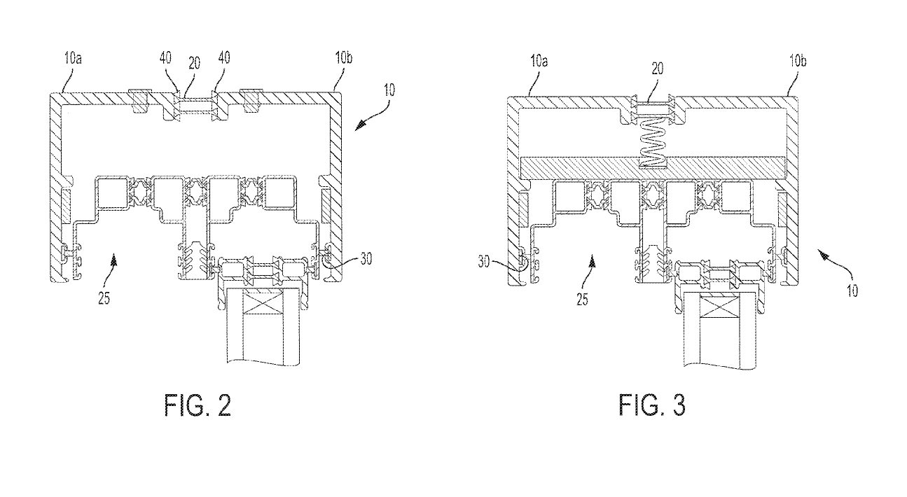

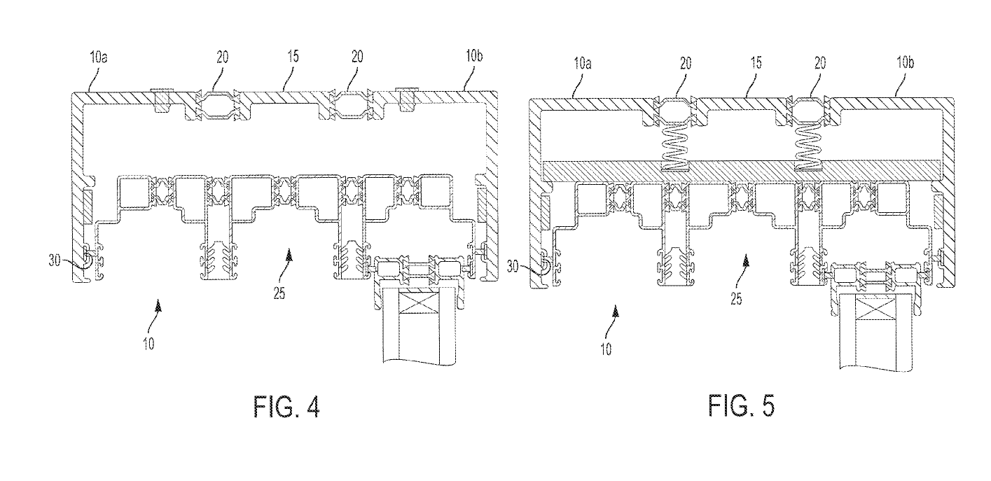

As shown in FIGS. 2 and 3, the header 10 according to an exemplary embodiment includes a left header piece 10a and a right header piece 10b with an extender provided therebetween 15. The left header piece 10a (e.g., a first header piece) and the right header piece 10b (e.g., a second header piece) are attached to either side of the extender 15 by connectors 20, such that the left header piece 10a and the right header piece 10b are mirror images of each other. It will be understood that any number of connectors 20 can be used. It will also be understood that the header 10 can be provided without the extender 15, whereby the left header piece 10a and the right header piece 10b are connected to each other by one or more connectors, as shown in FIGS. 4 and 5.

The connector 20 not only connects the left header piece 10a, the right header piece 10b, and the extender 15 together, but also provides a release of thermal energy for the header 10. That is, according to one exemplary embodiment, the connector 20 may be a thermal connector which enables thermal energy to more efficiently escape through the connector. For example, while the connector 20 can be formed of any material known in the art, the material used to form the connector 20 can have an improved thermal efficiency over the material used for the left header piece 10a and the right header piece 10b. It will be understood that the left header piece 10a, the right header piece 10b, and the extender 15 can also be formed of any material known in the art. It will also be understood that the header 10 is not limited to use for sliding doors, but can also be used for windows.

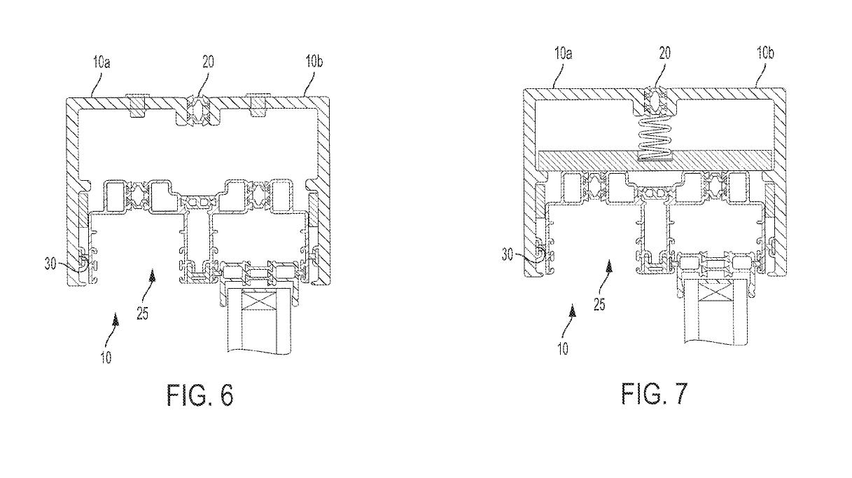

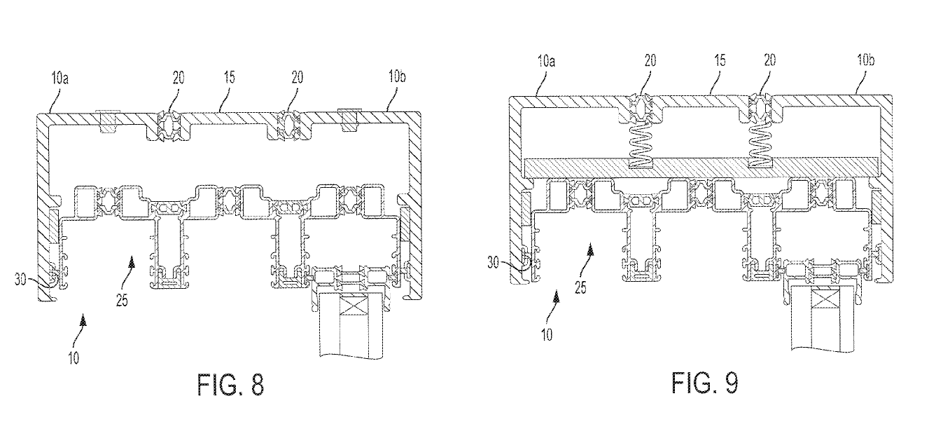

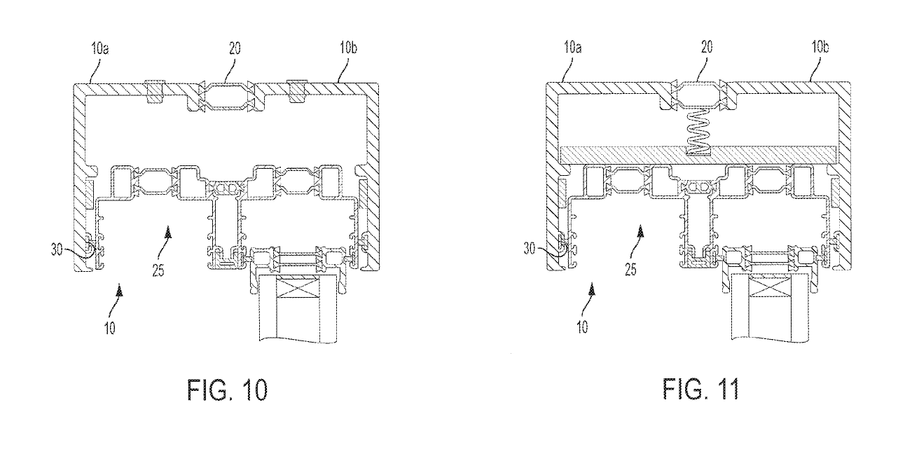

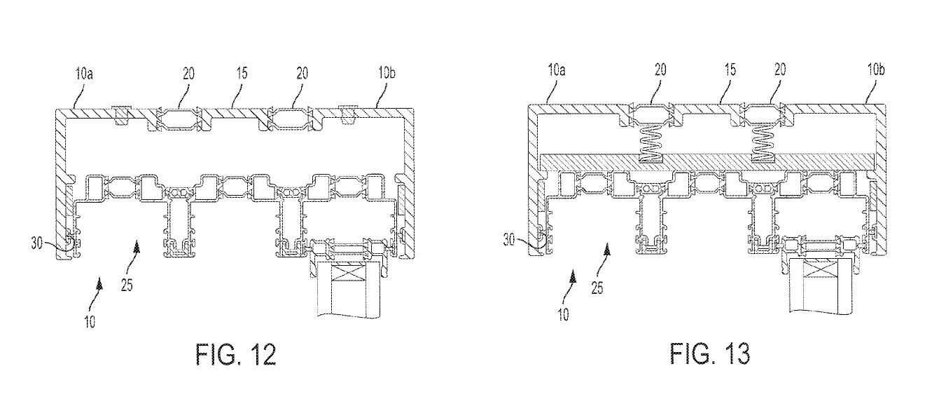

While the figures illustrate a single extender 15, the header 10 can be provided with any number of extenders 15 provided between the left header piece 10a and the second header piece 10b. The number of extenders 10 is determined according to the number of sliding panels and tracks necessary for the corresponding sliding doors or windows, as illustrated in, for example, FIGS. 4-14. While FIGS. 4-14 illustrate tracks 25 for allowing sliding doors or windows to move, it will be understood that roller tracks or other friction mitigation devices may be used to allow the sliding panels to be opened and closed, thereby minimizing the friction between the panels and the tracks 25.

Further, the header 10 can include slots or cuts to accommodate cabling (not shown), which can be used to move the sliding doors and windows.

The left header piece 10a and the right header piece 10b each include a first side and a second side. The first side and the second side are essentially perpendicular to each other. However, it will be understood that the first side and the second side can be joined so that the connection between the first side and the second side is curved or such that the angle of connection is greater than or less than ninety-degrees.

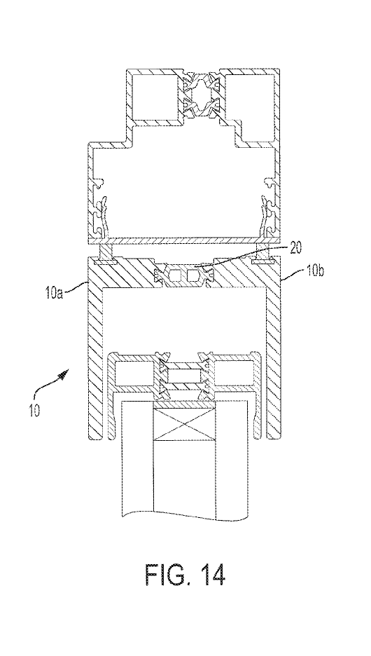

As shown in, example, FIGS. 2 and 3, the left header piece 10a and the right header piece 10b are also provided with protrusions 30 which are configured to receive or support a deflection device (not shown). The deflection device can be a bar formed from any material known in the art. The bar extends parallel along one of the first side and the second side of the left header piece 10a and the right header piece 10b. It will be understood that only one of the right header piece 10a and the left header piece 10b could include the protrusion 30 and the deflection device. In some embodiments, as illustrated in FIG. 14, neither the right header piece 10a nor the left header piece 10b include a protrusion 30.

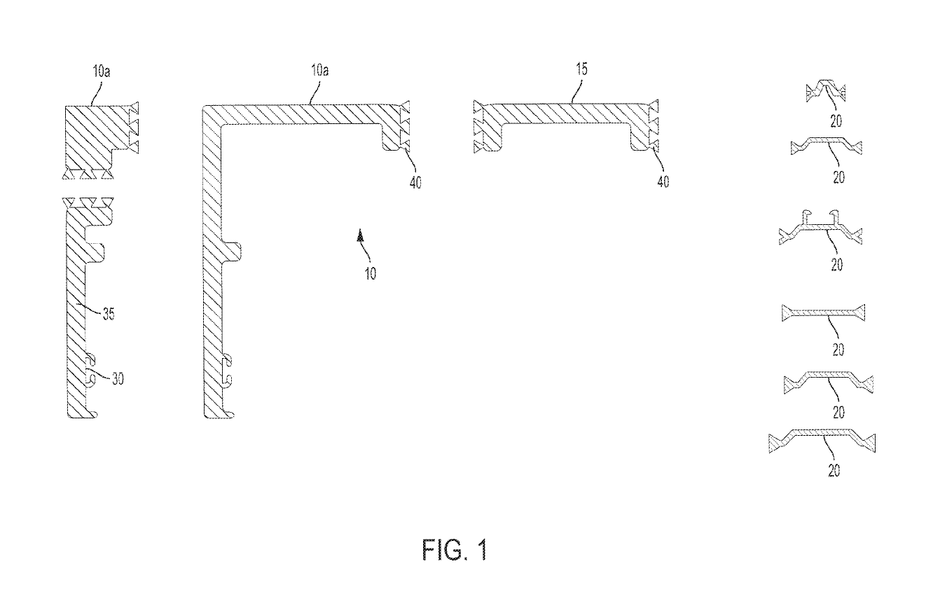

According to another exemplary embodiment, FIG. 1 illustrates how the left header piece 10a (or the right header piece 10b, not shown) can receive a connector 20 on at least two sides. This configuration allows not only the width of the header 10 to be extended, but also allows a user to change the height of the header 10 by including different vertical portions 35 using the connector 20 to provide different configurations.

FIG. 1 also illustrates various exemplary embodiments of the connector 20. The connector 20 can include any size, with a preference of between 12 mm and 36 mm in length. The connector 20 can have any shape, including a straight bar shape, a shape in which each end is angled from the body of the connector 20, or the connector 20 can include additional projections 20c to allow the connector 20 to attach to another device. As shown in FIG. 1, each end 20a, 20b of the connector 20 is flared, which allows the connector 20 to connect to the left header piece 10a, right header piece 10b, and extender 15 at connection portions 40.

According to another exemplary embodiment, brushes, gaskets, and thermal breaks (not shown) may be placed at any location along the header 10. That is, the header is intended to have multiple configurations depending on the requirements of the user.

In another exemplary embodiment as illustrated in FIG. 14, the header 10 can be used in a configuration in which a deflection device is provided on a pivoting panel. In this configuration, the deflection device ensures that the deflection channels compress so that the doors or windows pivot or rotate when the deflection device is mounted on the pivoting panel. The header 10 allows for various sized deflection devices to be used, while also providing a thermal break through the connector 20 to allow heat to dissipate from device. Use of the header 10 is not limited to a pivoting panel, and may be used in any door and/or window configuration known to those of skill in the art.

While the exemplary embodiments have been particularly shown and described, it will be understood by those of ordinary skill in the art that various changes in form and details may be made therein without departing from the spirit and scope of the inventive concept as defined by the appended claims

What is claimed is:

1. A header, comprising:
a first header piece; and
a second header piece, attachable to the first header piece,
wherein the first header piece and the second header piece are connected by a connector.

2. The header of claim 1, further comprising:
an extender provided between the first header piece and the second header piece,
wherein the first header piece is attached to a first side of the extender by at least one connector, and
the second header piece is attached to a second side of the extender, opposite the first side, by the at least one connector.

3. The header of claim 1, wherein the first header piece and the second header piece each include a first side and a second side, the first side being essentially orthogonal to the second side.

4. The header of claim 3, wherein at least one of the first header piece and the second header piece includes a protrusion on at least one of the first side and the second side, the protrusion being configured to receive or support a deflection device for deflecting top-hung tracks or floor tracks.

5. The header of claim 4, wherein the deflection device is a bar configured to rest on the protrusion.

6. The header of claim 3, wherein at least one of the first header piece and the second header piece does not include a protrusion on either the first side or the second side.

7. The header of claim 1, wherein the first header piece and the second header piece each include at least one protrusion which is configured to receive or support the at least one connector.
